(19) United States
(12) Patent Application Publication
(10) Pub. No.: US 2014/0377549 A1
(43) Pub. Date: Dec. 25, 2014

(54) Water resistant multilayer surface covering

(71) Applicant: Chun-Chieh Lu, Taipei (TW)

(72) Inventor: Chun-Chieh Lu, Taipei (TW)

(21) Appl. No.: 14/477,861

(22) Filed: Sep. 5, 2014

(51) Int. Cl. B32B 7/02

(52) U.S. Cl. CPC B32B 7/02; B32B 2250/03; B32B 2375/00; B32B 2315/00; B32B 2405/00; B32B 2307/7265
USPC 428/351

(57) ABSTRACT

A multilayer surface covering is provided with an intermediate layer formed of silicon or PU and being water resistant; a first adhesive layer disposed on a first surface of the intermediate layer; and a second adhesive layer disposed on a second surface of the intermediate layer. The intermediate layer has a thickness of between about 0.1 mm and 2 mm. The first adhesive layer is either releasably secured to the intermediate layer or permanently secured to the intermediate layer. The second adhesive layer is either releasably secured to the intermediate layer or permanently secured to the intermediate layer. Each of the first and second adhesive layers are configured to adhere to an uneven surface.

### BACKGROUND OF THE INVENTION

1. Field of the Invention

The invention relates to surface coverings and more particularly to a water resistant multilayer covering for uneven surface.

2. Description of Related Art

For interior decoration of a surface of home, decorative PVC (polyvinyl chloride) based surface coverings are widely used.

However, such “PVC” coverings have the drawback of being permeable to certain substances. In order to prevent this phenomenon, it was proposed to cover the outer surface of the upper and visible layer of the surface covering with a PU (polyurethane) type protective covering. However, this solution does not solve the problem of contaminants on the surface from entering the covering.

Thus, the need for improvement still exists.

### SUMMARY OF THE INVENTION

It is therefore one object of the invention to provide a multilayer surface covering comprising an intermediate layer formed of silicon or PU and being water resistant; a first adhesive layer disposed on a first surface of the intermediate layer; and a second adhesive layer disposed on a second surface of the intermediate layer; wherein the intermediate layer has a thickness of between about 0.1 mm and 2 mm; wherein the first adhesive layer is either releasably secured to the intermediate layer or permanently secured to the intermediate layer; wherein the second adhesive layer is either releasably secured to the intermediate layer or permanently secured to the intermediate layer; and wherein each of the first and second adhesive layers are configured to adhere to an uneven surface.

The above and other objects, features and advantages of the invention will become apparent from the following detailed description taken with the accompanying drawings.

### BRIEF DESCRIPTION OF THE DRAWINGS

FIG. 1 is a longitudinal sectional view of a multilayer surface covering according to a first preferred embodiment of the invention;

FIG. 2 is a longitudinal sectional view of a multilayer surface covering according to a second preferred embodiment of the invention;

FIG. 3 is a longitudinal sectional view of a multilayer surface covering according to a third preferred embodiment of the invention;

FIG. 4 is a longitudinal sectional view of the multilayer surface covering according to the first preferred embodiment adhered to a wall and an object adhered to the adhesive layer;

FIG. 5 is a longitudinal sectional view of the multilayer surface covering according to the second preferred embodiment adhered to a wall and a hook adhered to the hard, smooth layer; and

FIG. 6 is a longitudinal sectional view of the multilayer surface covering according to the third preferred embodiment adhered to a wall and a hook adhered to the non-rigid, smooth layer.

### DETAILED DESCRIPTION OF THE INVENTION

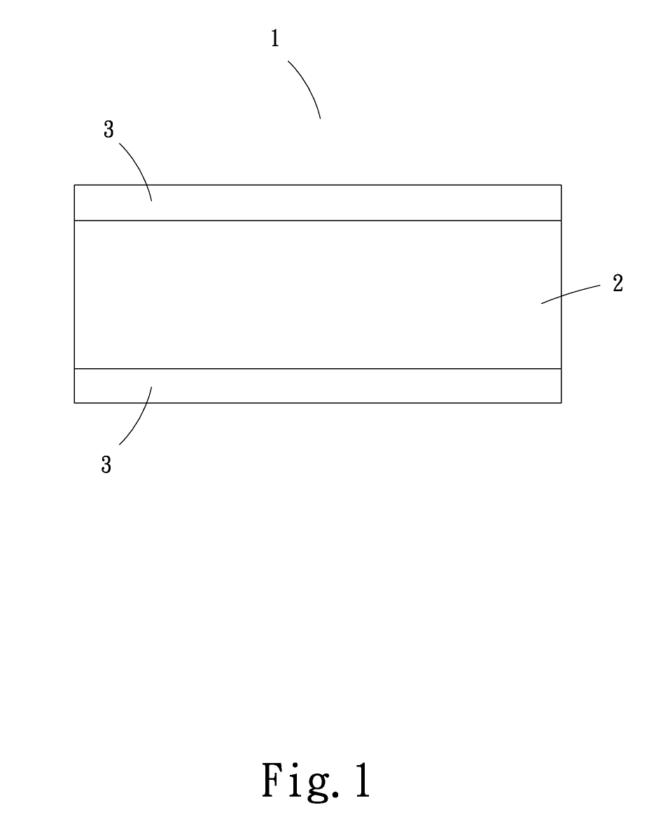

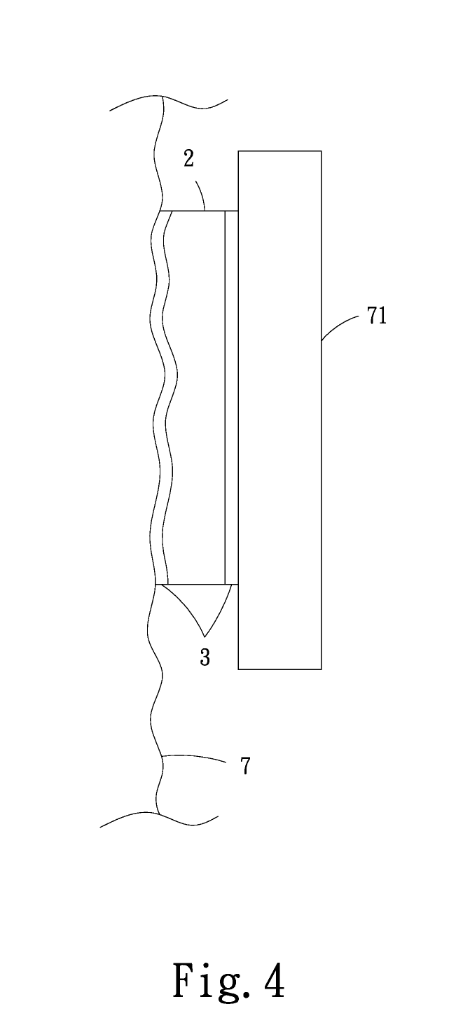

Referring to FIGS. 1 and 4, a multilayer surface covering 1 in accordance with a first preferred embodiment of the invention comprises the following components as discussed in detail below.

An intermediate layer 2 is formed of silicon or PU and is water resistant. Preferably, the intermediate layer 2 has a thickness of between about 0.1 mm and 2 mm. One surface of the intermediate layer 2 is formed with an adhesive layer 3 and the other surface thereof is formed with the adhesive layer 3. The adhesive layer 3 is either releasably secured to the intermediate layer 2 or permanently secured to the intermediate layer 2. As a result, the multilayer surface covering 1 is water resistant.

In use, one adhesive layer 3 is configured to adhere to an uneven surface of a wall 7 and an object 71 is adhered to the other adhesive layer 3.

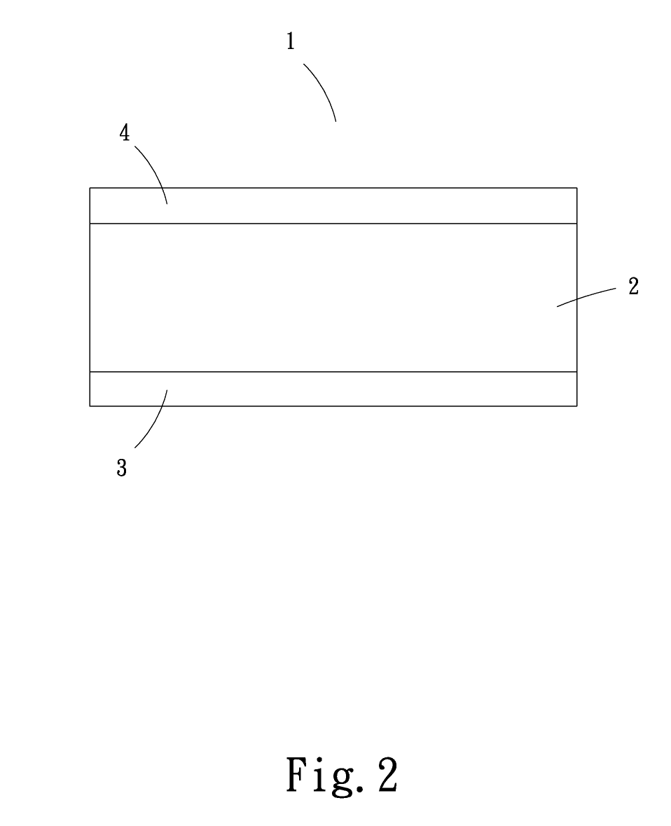

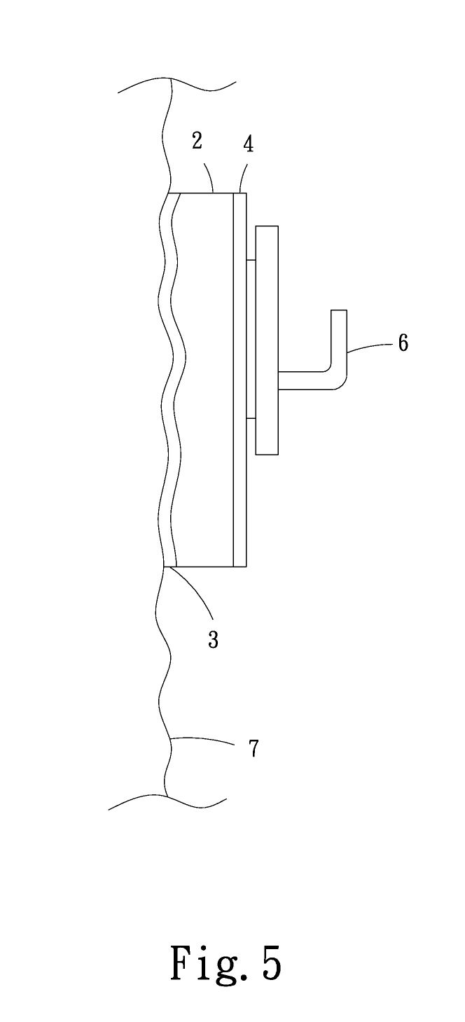

Referring to FIGS. 2 and 5, a multilayer surface covering 1 in accordance with a second preferred embodiment of the invention is shown. The characteristics of the second preferred embodiment are substantially the same as that of the first preferred embodiment except the following:

An other surface of the intermediate layer 2 is formed with a hard, smooth layer 4. As a result, the multilayer surface covering 1 is water resistant.

In use, one adhesive layer 3 is configured to adhere to an uneven surface of a wall 7 and a hook 6 is adhered to the hard, smooth layer 4 by adhesive or by suction cup. An object can be suspended on the hook 6.

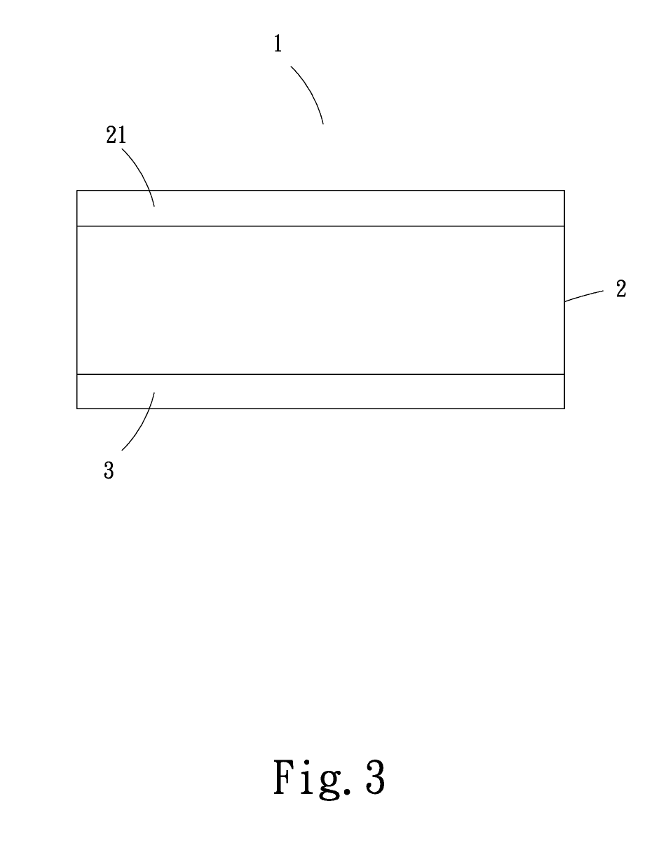

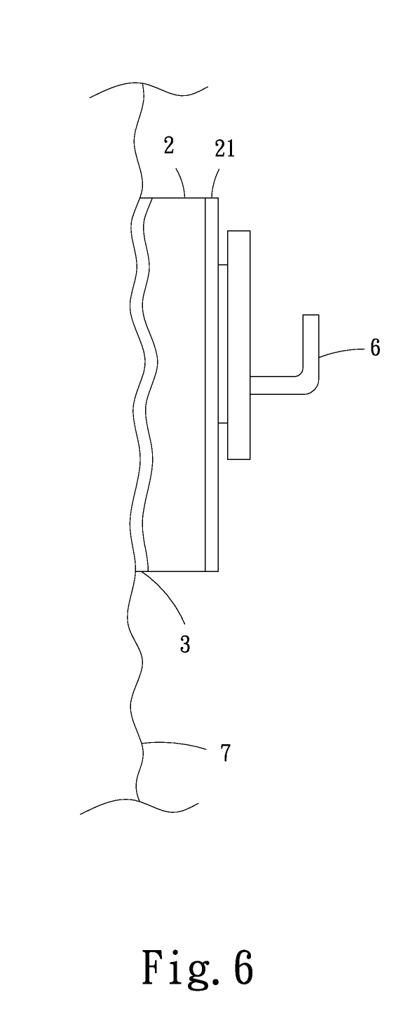

Referring to FIGS. 3 and 6, a multilayer surface covering 1 in accordance with a third preferred embodiment of the invention is shown. The characteristics of the third preferred embodiment are substantially the same as that of the first preferred embodiment except the following:

The other surface of the intermediate layer 2 is formed with a non-rigid, smooth layer 21. As a result, the multilayer surface covering 1 is water resistant.

In use, one adhesive layer 3 is configured to adhere to an uneven surface of a wall 7 and a hook 6 is adhered to the non-rigid, smooth layer 21 by adhesive or by suction cup. An object can be suspended on the hook 6.

While the invention has been described in terms of preferred embodiments, those skilled in the art will recognize that the invention can be practiced with modifications within the spirit and scope of the appended claims.

What is claimed is:

1. A multilayer surface covering comprising:
an intermediate layer formed of silicon or PU and being water resistant;
a first adhesive layer disposed on a first surface of the intermediate layer; and
a second adhesive layer disposed on a second surface of the intermediate layer;
wherein the intermediate layer has a thickness of between about 0.1 mm and 2 mm;
wherein the first adhesive layer is either releasably secured to the intermediate layer or permanently secured to the intermediate layer;
wherein the second adhesive layer is either releasably secured to the intermediate layer or permanently secured to the intermediate layer; and
wherein each of the first and second adhesive layers are configured to adhere to an uneven surface.

2. A multilayer surface covering comprising:
an intermediate layer formed of silicon or PU and being water resistant;
an adhesive layer disposed on a first surface of the intermediate layer; and
a hard, smooth layer disposed on a second surface of the intermediate layer;
wherein the intermediate layer has a thickness of between about 0.1 mm and 2 mm;
wherein the adhesive layer is either releasably secured to the intermediate layer or permanently secured to the intermediate layer; and
wherein the adhesive layer is configured to adhere to an uneven surface.

3. A multilayer surface covering comprising:
an intermediate layer formed of silicon or PU and being water resistant;
an adhesive layer disposed on a first surface of the intermediate layer; and
a non-rigid, smooth layer disposed on a second surface of the intermediate layer;
wherein the intermediate layer has a thickness of between about 0.1 mm and 2 mm;
wherein the adhesive layer is either releasably secured to the intermediate layer or permanently secured to the intermediate layer; and
wherein the adhesive layer is configured to adhere to an uneven surface.
